(19) United States
(12) Patent Application Publication
(10) Pub. No.: US 2006/0085987 A1
(43) Pub. Date: Apr. 27, 2006

(54) Pipe cutting device

(76) Inventor: Philip John Gordon, Cornwall (GB)

Correspondence Address: JOHN J. SCHROTH, P.E., 3598 BUTTONWOOD DRIVE, DOYLESTOWN, PA, 18901-5402, US

(21) Appl. No.: 11/255,525

(22) Filed: Oct. 21, 2005

(30) Foreign Application Priority Data
Oct. 22, 2004 (GB) GB0423469.6

(51) Int. Cl. B26D 3/16

(52) U.S. Cl. 30/92

(57) ABSTRACT

A pipe cutting device is provided. The device is based on a cutting member having a body with a radial pipe entry slot for receiving a pipe at a required cutting position along its length and having a cutting assembly for cutting the pipe upon rotation of the cutting member around the pipe. The device comprises a drive member having a drive means for causing the cutting member to rotate. The drive means is adapted to provide continuous drive to the cutting member body. Drive forces are not temporarily lost as the pipe entry slot rotates relative to a drive means.

### PRIOR APPLICATIONS

The present reference claims priority from United Kingdom Patent No. GB0423469.6 filed Oct. 22, 2004, the entire contents of which are herein incorporated by reference.

### BACKGROUND OF THE INVENTION

1. Field of the Invention

The present invention relates generally to a device for cutting pipes, tubing and the like. More specifically, the present invention relates to a powered or powerable pipe cutting device for the automated cutting of pipes, tubing and the like.

2. Description of the Related Art

It is known, for example from U.S. Pat. No. 4,831,732 and GB2288353, to provide a manual pipe cutting device comprising a cylindrical body with a longitudinal radial entry slot into which a pipe can be introduced. As the cylindrical body is manually turned around the pipe a cutting wheel is biased into contact with the pipe and progressively cuts into the pipe.

The advantage of a body with a radial slot is that it allows the pipe cutter to be introduced at any point along the length of the pipe as opposed to configurations without a slot, such as that shown in EP 0 483 076, in which a pipe must be inserted longitudinally through a cutting device. The presence of the radial slot allows, for example, the pipe cutter to be introduced to a pipe which is already connected at both ends and therefore does not have a free end over which the pipe cutter can be passed, and to be easily introduced to long pipes.

Referring now to FIGS. 1 and 2 there is shown a conventional pipe cutting member generally indicated 1. The cutting member 1 comprises a cylindrical body 2 having a radial slot 3 extending longitudinally there through. The slot 3 is defined by a slot wall 4 comprising two parallel side walls 4a, 4b and a U-shape bight 4c joining the side walls 4a, 4b.

The generally C-shape configuration of the body 2 allows the cutting member 1 to be placed around a cylindrical pipe 5 at a desired cutting point, with the pipe 5 resting in the semi-circular recess provided by the bight 4c. The cutting member 1 includes cutting means (not shown) operable such that when the body 2 is rotated about the longitudinal axis of the pipe 5 a cutting blade or the like is biased into contact with the pipe 5 and progressively produces a cut transverse its length. For the sake of simplicity and brevity the exact details of the cutting means are not described herein are asserted to be known to those of skill in the art.

A variety of cutting mechanisms have been proposed, such as in patent documents U.S. Pat. No. 4,831,732 and GB2288353 (both incorporated herein by reference), and all that is required for such cutting mechanisms is that the cutting member cuts the pipe when rotated about the longitudinal axis thereof.

What is not appreciated by the prior art is the need for an automated drive for a pipe cutter readily adapted to a variety of drive-power sources.

Accordingly, there is a need for an improved pipe cutting device.

### OBJECTS AND SUMMARY OF THE INVENTION

An object of the present invention is to provide an improved pipe cutting device readily adapted to an automated drive assembly and a variety of drive-power sources, as will be discussed.

The present invention relates to a pipe cutting device. The device is based on a cutting member having a body with a radial pipe entry slot for receiving a pipe at a required cutting position along its length and having cutting means for cutting the pipe upon rotation of the cutting member around the pipe. The device comprises a drive member having drive means for causing the cutting member to rotate. The drive means is adapted to provide continuous drive to the cutting member body. Drive is not temporarily lost as the pipe entry slot rotates passed the drive means.

The present invention is based on the desire to provide automated drive to a pipe cutter of the known type described above. The problem addressed is to provide uninterrupted drive to a body having a generally C-shape configuration hich includes a radial slot and in particular to provide drive over the gap in the body defined by the radial slot.

According to a first aspect of the present invention there is provided a drive device for causing rotation of a cutting member of the type having a body with a radial pipe entry slot for receiving a pipe at a required cutting position along the length thereof, and having cutting means for cutting a pipe upon rotation of the body about a longitudinal axis thereof; the drive device comprising drive means for causing the cutting member body to rotate relative thereto, in which, in use the drive means is formed so as to provide substantially continuous drive to the cutting member body.

The drive device may further comprise a cutting member. The cutting member may be provided as an integral part of the drive device or may be provided as a separate unit which is associatable with the drive device.

According to a second aspect of the present invention there is provided a pipe cutting device comprising: a cutting member having a body with a radial pipe entry slot for receiving a pipe at a required cutting position along the length thereof, and having cutting means for cutting a pipe upon rotation of the cutting member about the longitudinal axis thereof; and drive means for causing the cutting member to rotate relative thereto, in which, in use, the drive means is formed so as to provide substantially continuous drive to the cutting member body.

The present invention therefore provides a device incorporating or adapted to incorporate a cutting member of a known general type in which rotation is used to cut a pipe. Drive means for causing the cutting member body to rotate are provided and as a result the body rotates relative to the drive means. In order to provide substantially continuous drive to the cutting member body the drive means is formed so as to be in substantially continuous driving engagement with the body. Substantially uninterrupted drive is therefore provided to the cutting member body and this facilitates the automation of the cutting process where previously it had not been possible because of the requirement to provide drive across the pipe entry slot as its entrance rotates passed the drive means.

The drive means may be formed to provide continuous drive by being in continuous driving engagement with the body.

In order to provide drive to that part of the cutting member body comprising the pipe entry slot the drive means may be adapted to apply drive to the wall of the pipe entry slot. Drive is thereby not temporarily lost when the slot rotates passed the drive means.

The drive means may include an operative portion adapted to engage the pipe entry slot wall and to apply drive thereto.

The drive means may include an operative portion which is formed so as drivingly to engage the pipe entry slot as the slot rotates. In this way when the slot passes over the drive means drive to the body is not interrupted.

The operative portion may comprise a projection, such as a cam, tooth, detent or the like. The operative portion may therefore be formed so as to enter the slot and engage the slot wall to provide drive to the body.

The cutting member may have a drive surface for receiving drive from the drive means.

At least part of the drive surface may form part of the body. For example teeth or other projections for receiving drive may be cut into or formed on the body.

Alternatively or additionally at least part of the drive surface may be formed separate from and be attachable to the body. For example, a jacket-like or strap-like member could be provided for attachment to the body to provide a drive surface. Accordingly an existing cutting member could be retrofitted with a drive surface and the cutting member body requires no modifications.

The wall of the pipe entry slot may form part of the drive surface.

The drive means may be provided on a rotatable drive member. The drive member can therefore itself be driven to rotate and this rotation can be transferred, in the form of counter-rotation, to the cutting member by the drive means. A system of counter-rotating wheel-like members is mechanically simple and easy to manufacture.

In order that the operative portion of the drive means engages the slot at the same point along its rotational path on every rotation it is important that the cutting member and drive member do not slip relative to each other.

Accordingly the device may be formed so that the relative rotational positions of the cutting member and the drive member can be controlled and precisely determined so that the operative portion of the drive means aligns with the slot each time it rotates relative to the cutting member.

The cutting member and the drive member may be formed as co-operating cog wheels. Accordingly the drive means include the teeth of the drive member cog wheel which engage co-operating teeth on the cutting member body to transfer rotation. Alternatively, the drive member may transmit rotation to the cutting member at least partly by frictional engagement. Accordingly the drive member and/or the cutting member may be formed from or coated with a material having a high coefficient of friction so that rotation can be transferred.

The device may include a housing within which the cutting member is rotatable, and the drive means may also be provided in the housing so that the cutting member and the drive member can be placed and held in a required relative rotational position and the device can be supplied as a single unit.

The device may be motor-driven. Motive power may be provided by any convenient means such as a rotary motor.

The drive means may be motor-driven. The motor for powering the drive means may be formed as part of the device or may be provided by an external source, with the device adapted to receive drive from that external source.

The drive means may include a drive shaft which is engageable either by a motor formed as part of the device or engageable by an external drive source. For example, the device may include a drive shaft which is engageable by a power tool such as a drill in which rotation of the drill head can be transferred first to the drive shaft and then to the drive means for transfer to the cutting member body. It should be understood, that in an alternative embodiment such a drill may be used as and understood as an electric motor to drive the drive means. Thus the use of the descriptive phrase “drill” is not limiting to an particular hand drill, or stationary drill but should be broadly understood as an electric motor.

The cutting member body may be engaged at a single point by the drive means to provide rotation. By engaging the cutting member body only at a single point the complexity of the drive means can be reduced compared to a system involving multiple points of contact.

Accordingly, substantially uninterrupted drive causing the cutting member to rotate can be provided by the drive mechanism. Powered drive is therefore provided even as the entrance to the slot rotates passed the drive means.

The drive means may be adapted to provide drive in the absence of direct physical engagement. In this way the problem of engagement over the slot is overcome.

The drive means may comprise magnetic means for generating one or more magnetic fields and the cutting member may include means responsive to each magnetic field to cause the cutting member to rotate.

For example the cutting member may be provided with one or more magnetic elements around its periphery and the drive means comprises a series of electro-magnets which can be selectively energised. By selectively energising and de-energising the electro-magnets the magnetic elements could be attracted in a sequence which causes the cutting member to rotate without requiring any physical contact.

A further possibility to overcome the problem of drive over the slot is to form the cutting member as a flywheel so that sufficient kinetic energy, or a means for imparting sufficient kinetic energy, could be imparted to the member to allow the slot to pass drive means which operate by direct physical engagement, without causing loss of rotation.

The above and other objects, features and advantages of the present invention will become apparent from the following description read in conduction with the accompanying drawings, in which like reference numerals designate the same elements.

### BRIEF DESCRIPTION OF THE DRAWINGS

The present invention will now be more particularly described, by way of example, with reference to the accompanying drawings, in which:

FIG. 1 is a diagrammatic section of a conventional pipe cutting member.

FIG. 2 is a diagrammatic perspective view of the pipe cutting member of FIG. 1 together with a pipe.

FIGS. 3A to 3D illustrate the working mechanism of a pipe cutting device according to an embodiment of the present invention.

FIG. 4 is a diagrammatic section of a pipe cutting device including drive means according to an alternative embodiment.

FIG. 5 is a diagrammatic section of a pipe cutting device according to a further embodiment.

FIG. 6 is a side elevation of the pipe cutting device of FIG. 5.

FIG. 7 is a diagrammatic front elevation of the pipe cutting device of FIGS. 5 and 6 shown connected to an external drive source.

FIG. 8 is a diagrammatic view of the pipe cutting device of FIGS. 5 and 6 together with an alternative external drive source.

FIG. 9 is a diagrammatic section of a device according to an alternative embodiment.

FIG. 10 is a diagrammatic section of a device according to a further embodiment.

FIG. 11A is a perspective view of a cutting member formed as part of a cutting device according to an alternative embodiment.

FIG. 11B is a plan view of a drive jacket for use in conjunction with the cutting member of FIG. 11A.

FIG. 11C is a perspective view of the cutting member of FIG. 11A fitted with the jacket of FIG. 11B.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, front, back, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

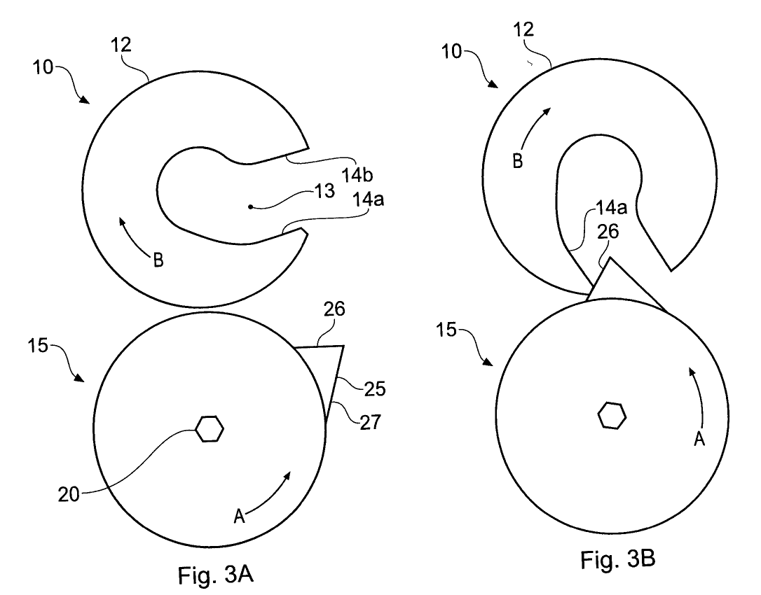

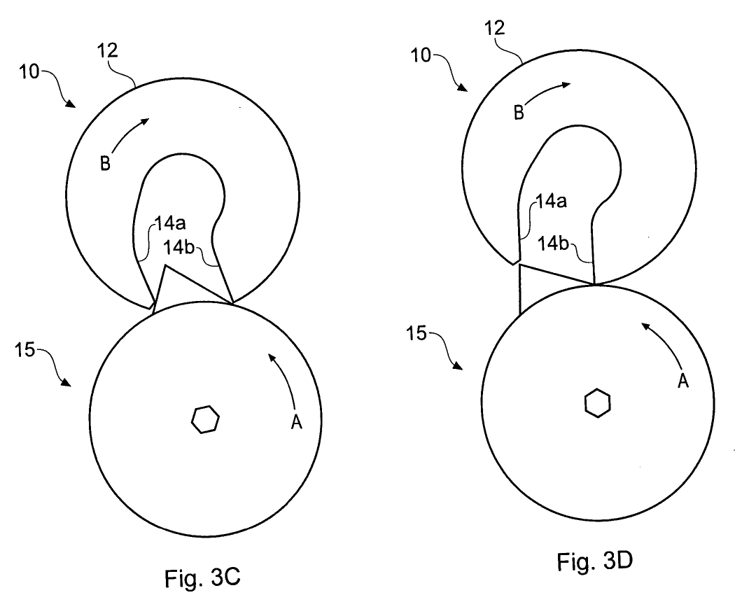

Referring now to FIGS. 3A to 3D there is shown the principles of the working mechanism behind a pipe cutting device according to an embodiment of the present invention.

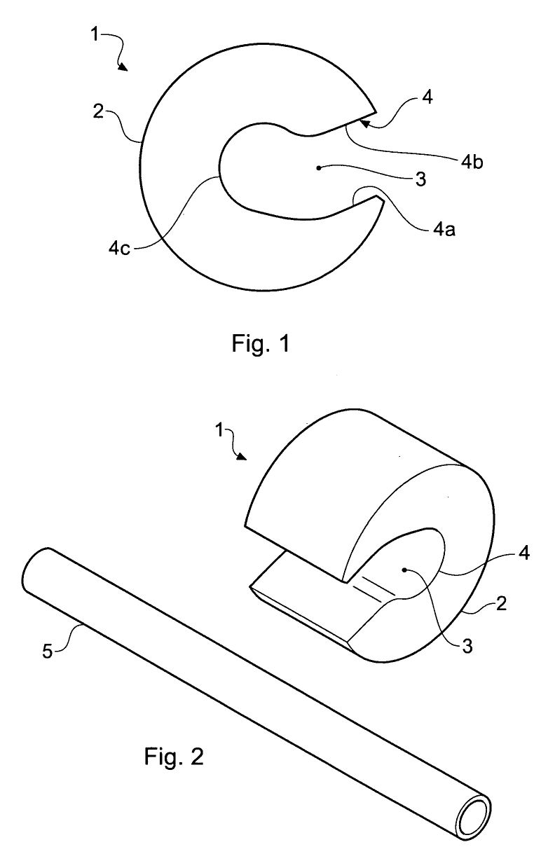

Referring first to FIG. 3A there is shown a cutting member 10 of the general type shown in FIGS. 1 and 2. A generally circular rotatable drive member 15 is rotatable about a drive axis defined by a drive shaft 20 in the direction indicated by arrow A. The cutting member 10 and the drive member 15 are coated with a material having a high coefficient of friction such that when the drive member 15 is adjacent the cutting member 10 and is rotated, the rotation is transferred to the cutting member 10 to produce counter-rotation in the direction of arrow B.

The surface of the drive member 15 is smoothly curved with the exception of a tooth 25 which projects at a specified point on the circumference of the member 15 relative to the slot of the member 10. The tooth 25 includes a ramped surface 26 and an inclined surface 27.

As the members 10, 15 rotate relative to each other eventually the slot 13 of the cutting member 10 rotates to the point at which the slot 13 starts to rotate passed the driving member 15. Accordingly the exterior surfaces of the members 10, 15 are no longer in direct rolling contact and an alternative way of transferring drive must be provided. The profile and the positioning of the tooth 25 is such that as the slot 13 approaches the driving member 15 the ramped face 26 of the tooth 25 enters the slot 13 and engages the slot wall 14a so that the driving member 15 can continue to transfer rotation to the cutting member 10. FIG. 3B shows the relative position of the members 10, 15 as the exterior curved surfaces of the member 10, 15 lose contact with each other and the tooth surface 26 engages the slot wall 14a.

In FIG. 3C, continued rotation of the driving member 15 now pushes the cutting member 10 via the tooth 25. The inclined face 27 of the tooth 25 means that the tooth 25 can rotate into the slot 3 freely and without contacting the wall 14b.

In FIG. 3D the driving member 15 has rotated to the point at which the tooth 25 starts to leave the slot 13 and the cutting member body 12 adjacent the slot wall 14b re-engages the driving member 15 so that the transfer of rotation can continue, without having been interrupted by the passing of the slot 13. The driving member 15 therefore includes the facility to push the cutting member 10 passed the slot 13 and to provide continuous drive.

The diameters of the cutting member 10 and the drive member 15 are substantially the same, although this is not required in alternative embodiments as will be later described. In addition, the circumferential extent of the tooth 25 is substantially the same as the slot 13 (as shown best in FIG. 3D). Accordingly the circumferential length of the members 10, 15 in rolling contact with each other as they rotate is substantially equal. Assuming that there is no relative slippage between the members 10, 15 this means that the tooth 25 will be at the same point relative to the slot 13 each time the drive member 15 rotates.

In other embodiments (not shown) the reverse driving arrangement is provided in which the drive member 15 has a recess into which the slot wall 14a passes. The wall is then engaged by the recess wall to provide drive.

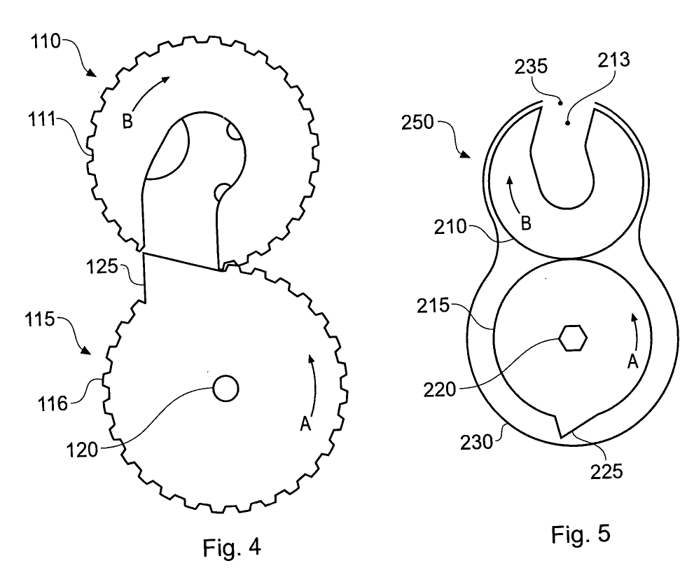

Referring now to FIG. 4 there is shown an alternative drive mechanism. In this embodiment the cutting member 110 and the drive member 115 are formed as cog wheels with the drive member have a plurality of circumferential cog teeth 116 and the cutting member having a plurality of co-operating cog pockets 111 engageable by the teeth 116 to allow the transfer of rotation from the drive member 115 to the cutting member 110 via a cog-teeth engagement mechanism. In this embodiment the driving member also has a tooth 125 of the same type as that shown in FIGS. 3a to 3d and the working mechanism is the same. In this embodiment therefore the drive means of the drive member comprise the teeth 116 and the tooth 125 which together provide for the continuous transfer of rotation from the drive member 115 to the cutting member 110.

Referring now to FIG. 5, a drive member 215 and a cutting member 210 formed according to the present invention are provided. The drive member 215 is Rota table via a drive shaft 220 and includes a tooth 225 for engaging and driving the slot 213 of the cutting member 210 in the same way as described in relation to FIGS. 3 and 4.

While in theory the members 210, 215 could be provided separately and brought together at the point of use, it may be preferable for them to be more permanently associated, for example to allow their relative positions to be fixed. In this embodiment the members 210, 215 are provided in a housing 230 which is in section generally in the shape of the number eight in outline and together they form a hand-held cutting device generally indicated 250. The cutting member 210 is rotatably supported in the housing 230 by any convenient means such as rollers (not shown) or the like. The housing 230 includes an opening 235 and the slot 213 of the cutting member 210 can be aligned with the opening 235 so that a pipe (not shown) can be introduced through the opening 235 and into the slot. In some embodiments (not shown) the device includes the facility to ensure that the slot 213 and opening 235 are always aligned when the device 250 is not in use so that the device is always ready to receive a pipe. Following insertion of a pipe the mode of operation of the device is as described in relation to FIGS. 3A to 3D and FIG. 4.

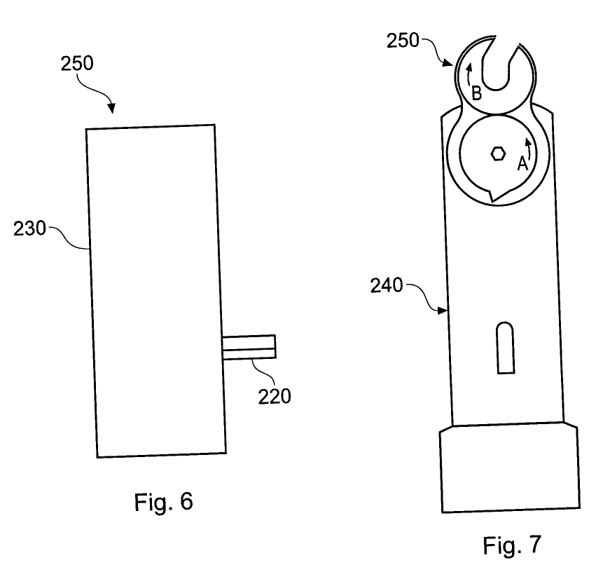

Referring now to FIG. 6 a side view of the device 250 of FIG. 5 shows that the hexagonal drive shaft 220 extends from the housing 230.

Referring now also to FIG. 7 the protruding drive shaft 220 allows the device 250 to be connected to an external drive source, which in this embodiment is a powered drill 240 shown end-on. Rotation of the drill head (not shown) causes the drive shaft 220 to rotate which in turn transfers drive to the drive member 215 and then to the cutting member 210 to effect the cutting of a pipe. In this embodiment therefore the power for the drive member 215 is provided by an external power source which is connectable to the device 250. In other embodiments (not shown) the power source is provided in the device itself and accordingly the device incorporates a motor or the like as will be understood by those of skill in the art of designing pipe cutting devices to enable a self-contained operation.

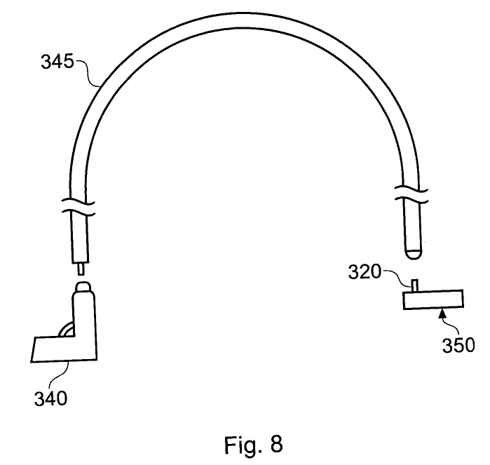

Because the device of FIGS. 6 and 7 is connectable to an external power source the nature of the power source which drives the device can be selected for a required circumstance. For example, in FIG. 8 a drill 340 is connected to the device 350 via a flexible drive shaft 345, which would allow the device to be operated in confined spaces.

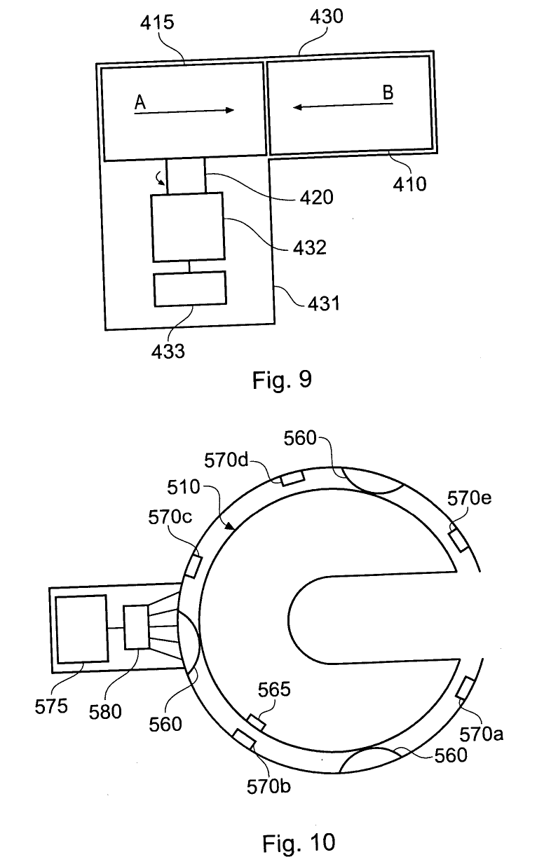

Referring now to FIG. 9 there is shown a device according to an alternative embodiment. The embodiment is based on the same type of device shown in FIGS. 5 and 6 and accordingly a cutting member 410 and a drive member 415 are provided in a housing 430. A drive shaft 420 extends centrally from the drive member 415. In this embodiment the housing 430 includes a leg 431 which extends from the side of the housing 430 which accommodates the drive member 415 and results in a generally L-shaped housing.

The leg 431 accommodates a rotary motor 432 connected to the drive shaft 420, and a battery 433 for powering the motor 432. Battery 433 should be understood by those of skill in the art to be readily adaptable as a replaceable or rechargeable battery enabling continuous operation. Alternatively, battery 433 may be replaced by an electric supply cord (not shown) to drive rotary motor 432 in a manner understood by those of skill in the art of designing powered tool mechanism. As an additional benefit, conveniently the leg 431 forms a handle by which the device can be manipulated.

In use the motor 432 rotates the shaft 420 and the operation of the device is then as described in relation to FIGS. 5 and 6.

In this embodiment therefore the device includes an integral power source and motor for providing drive.

Referring now to FIG. 10 there is shown a further alternative embodiment. A housing 530 accommodates a cutting member 510 of the general type shown in FIGS. 1 and 2. The cutting member 510 is rotatably supported in the housing 530 on rollers 560.

The cutting member 510 has a magnetic element 565 embedded in its surface at a point on its periphery.

The housing 530 is provided with five electro-magnets 570a-e spaced around its interior. The electro-magnets 570a-e can be selectively energised and de-energized by a power supply 575 and switching means 580. The electro-magnets 570a-e can be energized to cause the magnetic element 565 to be variously attracted or repelled and consequently rotate the member 510. By energizing and de-energizing the magnets 570a-e in sequence the member 510 can be continuously rotated without physical engagement. This drive mechanism could be used to rotate the member 510 in either direction by changing the sequence of energizing and de-energizing the electro-magnets 570a-e.

In yet another alternative embodiment of the present invention, electro-magnets 570a-e are removed, and rollers 560 receive a driving force. In such an embodiment, as at least two rollers 560 contact cutting member 510 through out a rotation cycle, rotating power provided continuously vi rollers 560 will smoothly rotate a cutting member without the cost of an electromagnetic assign.

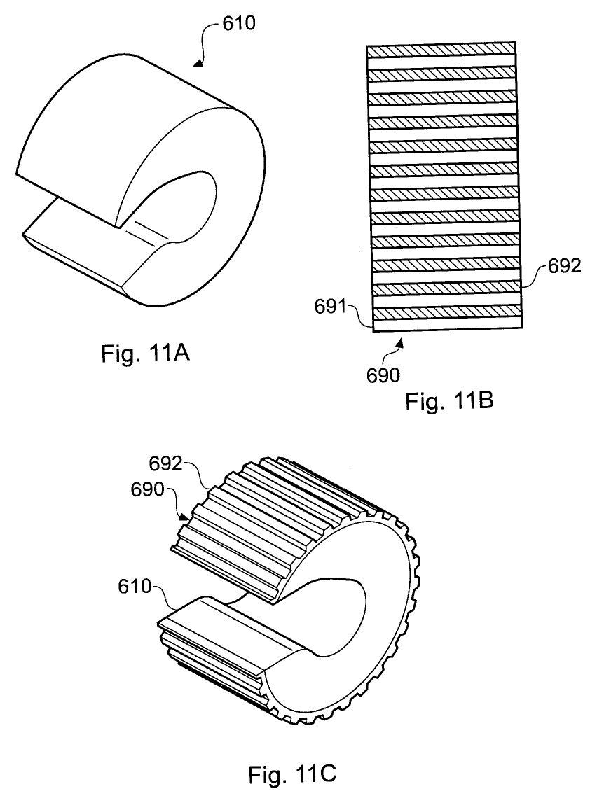

Referring now to FIGS. 11A, 11B and 11C there is shown a cutting member 610 and an attachable drive surface 690.

The drive surface 690 comprises a rubber sheet 691 formed with a plurality of teeth 692 extending transverse its length.

The surface 690 is sized so that it can be wrapped around the curved exterior of the member 610 to form a drive jacket. The drive surface 690 can then serve to receive drive force from a drive member 115 of the type shown in FIG. 4 without the requirement for modification of the cutting member body itself.

Since the sheet 691 is formed from rubber, or other another high molecular weight elastomeric material, it has a high coefficient of friction and relative slippage between the sheet and the member 610 is prevented.

The surface 690 may be permanently secured to the body, such as by adhesion or welding, or temporarily attaching so as to be removably-attached.

Those of skill in the art should recognize, that as used herein for the preferred embodiment, the pipe cutting members possess a cylindraceous outer boundary in which the slot penetrates the outer boundary thereof. The descriptive phrase cylindraceous shall be understood as descriptive language referring to a body that has a generally curved outer boundary, and includes elliptical, ovoid, uniform and non-uniform curved boundary forms. Nothing herein should limit the understanding of those skilled in the art of pipe cutting members or drive devices to a uniform shape or continuous or uniform outer boundary, nor shall anything herein require the pipe cutting member to be a geometrically uniform cylinder along its length.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A drive device for causing rotation of a cutting member, the cutting member having a body with a radial pipe entry slot defined in an outer boundary for receiving an external pipe for cutting at a required cutting position; and having cutting means for cutting said external pipe upon a rotation of said body about a rotation axis thereof,
said drive device comprising:
at least a first drive means for providing a substantially continuous rotational driving force to said body, whereby said at least first drive means rotates said body during a use about said rotation axis independent of a position of said slot.

2. A drive device, according to 1, wherein:
said at least first drive means for providing includes means for maintaining a substantially continuous drive-engagement with said body during said use; and
said substantially continuous drive-engagement including at least one of a physical contact drive-engagement, an electromagnetic drive-engagement, a frictional drive-engagement, and a cog-teeth drive-engagement, whereby said means for maintaining enables said drive means to impart a substantially continuous drive force to said body during said rotation.

3. A drive device, according to claim 2, wherein:
said drive-engagement includes said physical contact drive-engagement;
said at least first drive means includes a rotatable drive member; and
said rotatable drive member includes an operative member projecting from said drive device adapted to engage at least one wall of said pipe entry slot during said use.

4. A drive device, according to claim 3, wherein:
said at least one wall of said pipe entry slot is a drive surface for receiving a drive force from said at least first drive means; and
said operative member includes a cam surface for contacting said drive surface and imparting said drive force during said use.

5. A drive device, according to claim 2, wherein:
said drive-engagement includes said electromagnetic drive-engagement;
said at least first drive means further comprises:
at least one means for generating at least one switchable magnetic field; and
said cutting member further comprises:
means for responding to said at least one switchable magnetic field, whereby said at drive device imparts electromagnetic force to said cutting member causing said cutting member to rotate during said use.

6. A drive device, according to claim 5, further comprising:
a support housing for supporting said body during said use; and
bearing means for rotatably bearing said rotatable body during said use, whereby said rotatable body receives at least a three-point bearing contact during each rotation.

7. A drive device, according to claim 2, wherein:
said drive-engagement includes said cog-teeth drive-engagement;
said at least first drive means includes a rotatable drive member; and
a first plurality of cog-teeth on an exterior surface of said rotatable drive member in driving cooperation with a second plurality of cog-teeth on an exterior surface of said cutting member, whereby a rotational force is transferred to said cutting member.

8. A drive device, according to claim 2, wherein:
said drive engagement includes a frictional drive-engagement; and
said at least first drive means includes a rotatable drive member in at least partial frictional contact with said body of said cutting member, whereby during said use a frictional engagement between said drive member and said cutting member imparts a rotational drive force causing said body rotation about said rotation axis.

9. A drive device, according to claim 2, wherein:
said drive engagement includes said cog-teeth drive-engagement;
said at least first drive means includes a rotatable drive member;
an attachable drive surface including a plurality of teeth on an outer surface of said body as a drive jacket; and
ones of said plurality of teeth of said drive jacket engageable with drive ones of a plurality of teeth substantially bounding a drive surface of said rotatable drive member, whereby said drive jacket enables ready adaptation of said drive device to conventional cutting members.

10. A drive device, according to claim 2, further comprising:
a housing member;
said housing member substantially bounding and supporting a close rotational engagement between said cutting member and said drive device; and
a drive shaft member projecting from said drive device relative to said housing member enabling a receipt of an external rotation force at said drive shaft member and a transmission of said external rotation force from said at least first drive means to said cutting member via said substantially continuous drive engagement.

11. A pipe cutting system, comprising:
a cutting member;
said cutting member including a body with a radial pipe entry slot for receiving an external pipe for cutting at a required cutting position along a length thereof;
said cutting member including cutting means for cutting said external pipe upon a rotation of said body about a rotation axis; and
at least first drive means for providing a substantially continuous rotational driving force to said body, whereby said body is rotated about said rotation axis during a use.

12. A pipe cutting system, according to claim 11, further comprising:
said at least first drive means for providing includes means for maintaining a substantially continuous drive-engagement with said body during said use; and
said substantially continuous drive-engagement including at least one of a physical contact drive-engagement, an electromagnetic drive-engagement, a frictional drive-engagement, and a cog-teeth drive-engagement, whereby said means for maintaining enables said drive means to impart said substantially continuous driving force to said body during said use.

13. A pipe cutting system, according to claim 12, further comprising:
a housing for operably containing said cutting member and said at least first drive means, whereby said housing improves a user-safety of said pipe cutting system.

14. A pipe cutting system, according to claim 13, further comprising:
a driving shaft projecting from said at least first drive means for engaging and transmitting a driving force from at least a first means for providing a driving force.

15. A pipe cutting system, according to claim 14, wherein:
said means for providing a driving force includes at least one of an electric motor, a fuel-driven motor, and a flexible drive shaft transmitting a drive force from one of an electric and a fuel-driven motor.

16. A method for rotating a cutting member, said cutting member including a body with a radial pipe entry slot for receiving an external pipe at a predetermined cutting positioned; and having means for cutting said external pipe upon a rotation of said body about a rotation axis,
said method comprising the steps of:
providing at least a first drive means for causing said body to rotate relative to said rotation axis;
operably engaging said at least first drive means for causing with at least a portion of said cutting member to impart a drive rotation force; and
operating said at least first drive means for causing to impart said drive rotation force to said body during a use, whereby said external pipe rotates enabling relative to said rotation axis enabling a cutting thereof.

17. A method for rotating a cutting member, according to claim 16, further comprising the steps of:
prior to said step of operating, providing a housing member for operably securing said at least first drive means in a drive engagement with said cutting member; and
projecting a drive shaft member from said at least first drive means beyond a portion of said housing member for receiving a driving force,

18. A method for rotating a cutting member, according to claim 17, wherein:
said at least first drive means for providing further comprises:
means for maintaining a substantially continuous drive-engagement with said body during said use; and
said substantially continuous drive-engagement including at least one of a physical contact drive-engagement, an electromagnetic drive-engagement, a frictional drive-engagement, and a cog-teeth drive-engagement, whereby said means for maintaining enables said drive means to impart a substantially continuous drive force transmitted from said drive shaft member to said body during said use.

19. A method for rotating a cutting member, according to claim 16, wherein:
said at least first drive means for providing further comprises:
means for maintaining a substantially continuous drive-engagement with said body during said use; and
said substantially continuous drive-engagement including at least one of a physical contact drive-engagement, an electro-magnetic drive-engagement, a frictional drive-engagement, and a cog-teeth drive-engagement, whereby said means for maintaining enables said drive means to impart a substantially continuous drive force transmitted from said drive shaft member to said body during said use.

20. A method for rotating a cutting member, according to claim 19, wherein:
said drive-engagement includes said physical contact drive-engagement;
said at least first drive means includes a rotatable drive member; and
said rotatable drive member includes an operative member projecting from said drive device adapted to engage at least one wall of said pipe entry slot during said use.
